(19) United States
(12) Patent Application Publication
(10) Pub. No.: US 2018/0225716 A1
(43) Pub. Date: Aug. 9, 2018

(54) Location Based Advertisement System

(71) Applicants: Denny Lee Fry, Clarksville, TN (US); Tobin Otis Wells, Nashville, TN (US); Jeremy David Lee, Joelton, TN (US)

(72) Inventors: Denny Lee Fry, Clarksville, TN (US); Tobin Otis Wells, Nashville, TN (US); Jeremy David Lee, Joelton, TN (US)

(21) Appl. No.: 15/487,000

(22) Filed: Apr. 13, 2017

Related U.S. Application Data
(60) Provisional application No. 62/454,431, filed on Feb. 3, 2017.

(51) Int. Cl. G06Q 30/02

(52) U.S. Cl. CPC G06Q 30/0266; G06Q 30/0264; G06Q 30/0277; G06Q 30/0252

(57) ABSTRACT

An advertising system configured to enable advertisements to be configured by a user via the internet, and then scheduled for display as desired on the back of a bus or other remote fixed or mobile advertising site. The system includes a website configured to enable an ad buyer to log onto the website; upload and approve advertising graphics, and select variables for display of the advertising graphics; and a remote advertising display linked to the website via the internet. The advertisement is displayed on the remote advertising display based on the variables selected by the ad buyer.

### CROSS-REFERENCE TO RELATED APPLICATION

This application claims priority to U.S. Provisional Application Ser. No. 62/454,431, filed, Feb. 3, 2017, and entitled BUS ADVERTISEMENT SYSTEM, incorporated by reference herein in its entirety.

### FIELD

This disclosure relates to the field of mobile and remote advertising displays. More particularly, this disclosure relates to a system for displaying numerous advertisements via an advertising display located on remote and/or mobile sites, such as buses while providing WiFi to riders from a GPS device.

### BACKGROUND

Improvement is desired in regards to providing advertising. In particular, what is desired is a dynamic system that enables an ad buyer to quickly and easily configure advertising, and to have such advertising displayed at desired times and remote and transient locations.

### SUMMARY

In one aspect, the disclosure provides an advertising system configured to enable advertisements to be configured by a user via the internet, and then scheduled for display as desired on the back of a bus or other remote fixed or mobile advertising site.

The system includes a web site configured to enable an ad buyer to log onto the website; upload and approve advertising graphics, and purchase times and geographic locations for display of the advertising graphics; and a remote advertising display linked to the website via the internet. The advertisement is displayed on the remote advertising display at the times and geographic locations purchased by the ad buyer.

In another aspect, the system includes a website configured to enable an ad buyer to log onto the website; upload and approve advertising graphics, and select variables for display of the advertising graphics; and a remote advertising display linked to the website via the internet. The advertisement is displayed on the remote advertising display based on the variables selected by the ad buyer.

In another aspect, the disclosure provides a method of providing advertising.

The method includes the steps of providing a website configured to enable an ad buyer to log onto the website and enabling the ad buyer to upload and approve advertising graphics, and purchase times and geographic locations for display of the advertising graphics; providing a remote advertising display linked to the website via the internet, and displaying the advertisement on the remote advertising display at the times and geographic locations purchased by the ad buyer.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIGS. 1-4 show display of advertisements on the back of a bus according to bus advertising system of the disclosure.

FIGS. 5-12 show steps of the bus advertising system and method according to the disclosure.

### DETAILED DESCRIPTION

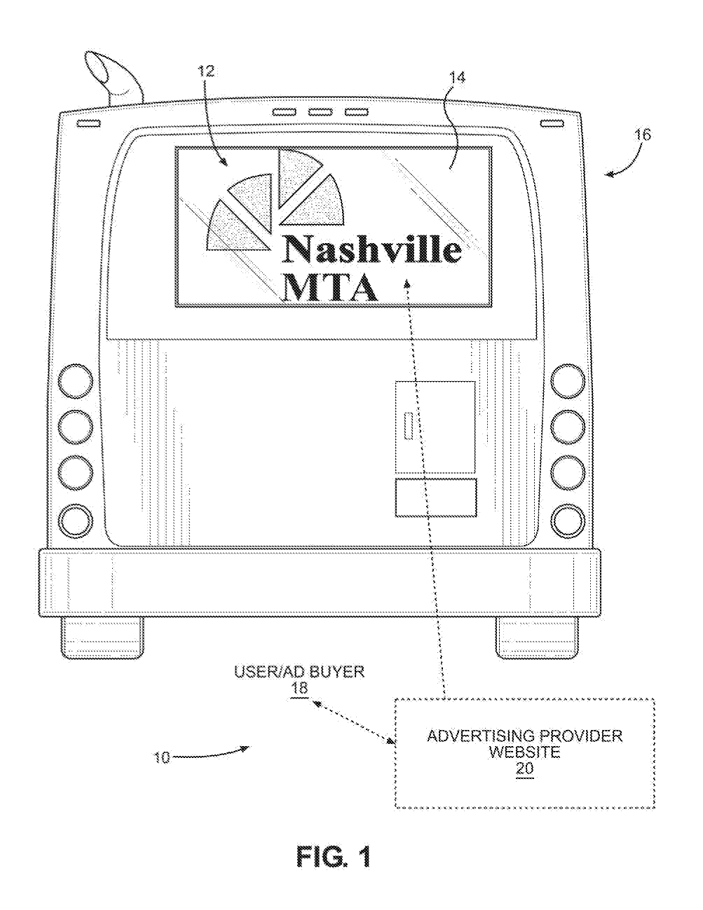

With initial reference to FIGS. 1-4, there is shown an advertising system 10. The system 10 enables advertisements to be configured by a user via the internet, and then scheduled for display as desired on a remote advertising site 12. The remote advertising site 12 may be a mobile advertising site or a fixed advertising site. As depicted, a display screen 14 located on the back of a bus 16 or other transit vehicle can provide a desired mobile advertising site. A display screen located at a fixed location, such as on a billboard, can provide a desired fixed advertising site.

For example, in one embodiment, a user or ad buyer 18 may log onto a web site 20 of the provider and upload advertising graphics. An ad for display is configured and the ad buyer may then view the ad via the website for approval. Once the ad is approved, the ad buyer purchases the advertising times and locations and the like for display of the ad. The ad is then sent for internal approval by the provider to screen for inappropriate content or the like. This may be done manually by a content editor, for example. Once the ad is approved, the ad is then displayed in accordance with the time/location and the like criteria selected by the ad buyer. The ad is directed from the website 20 to the display screen 14 via the internet.

One preferred mobile ad location is an LED screen or other advertising display located on the back of a city bus or the like transit vehicle. The ad buyer can choose to either have the ad displayed on the transit vehicle, regardless of location, or they can choose a specific geographic area where the transit agency operates. For example, the ad buyer could choose to have his ad display in bus region 1 of Nashville, Tenn., a defined geographic area of a bus route. The system would display the ad buyer's ads in region 1 on the rear of the transit vehicle. When the vehicle travels to region 2, only the ads designated for region 2 will display. In this regard, it will be appreciated that ads may be displayed on a per-bus or per-region basis.

The ad buyer may purchase as many regions as desired. Software associated with the system also allows the ad buyer to choose the time of day, temperature, weather, and special holidays to dictate how the ad would be displayed. There are no limits to the variables the ad buyer chooses. There are also no limits to the number of ads or timeframes the ad buyer can choose. The ads may be displayed singularly as daily up to one year or other desired time frame.

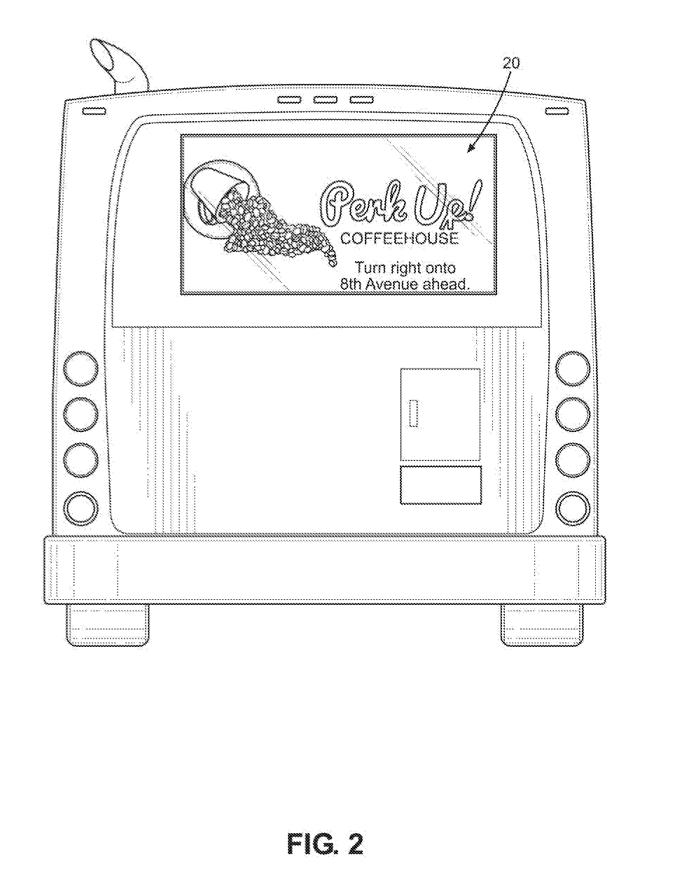

For example, a restaurant ad buyer may display ads in region 1 for the morning rush hours with their breakfast menu. Then in the evening rush hour, they could display the dinner menu. The ad buyer could also incorporate into the system that if during the morning rush the temperature was below 40 degrees, they could display hot beverage items, with the ad being displayed along with directions to the restaurant based on the current location of the display of the ad to the restaurant location. An example of this is shown by ad 20 as seen in FIG. 2. If the weather was over 80 degrees for the afternoon rush, the ad buyer chose to could display cold beverages. The ad buyer could also choose to have Monday-Wednesday-Friday in the mornings to run certain ads and in the evenings run other ads. Then on Tuesday-Thursday-Saturday-Sunday the ad buyer could chose to run other ads.

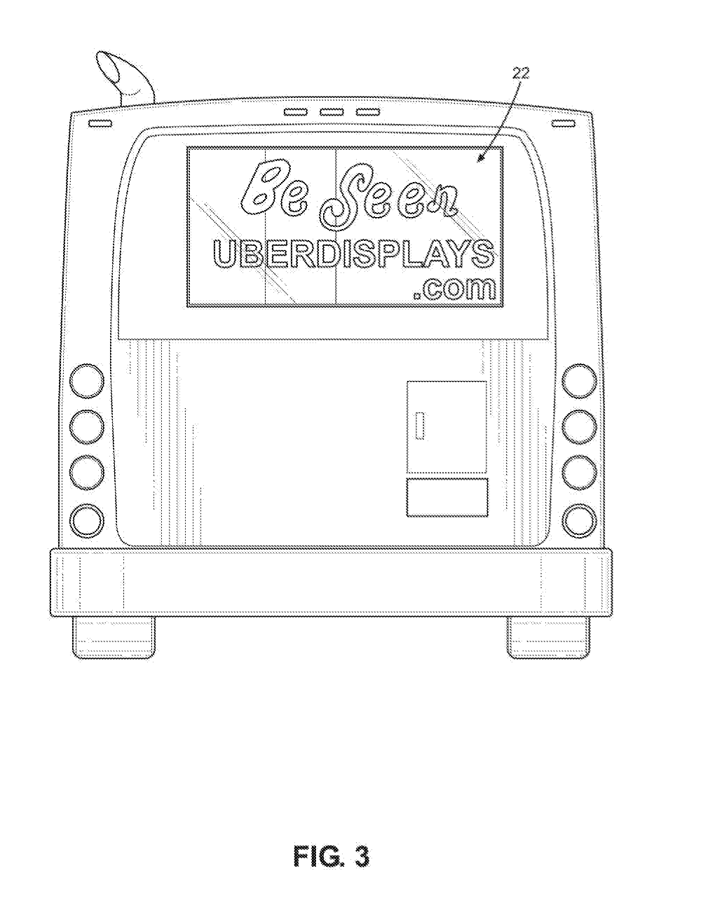

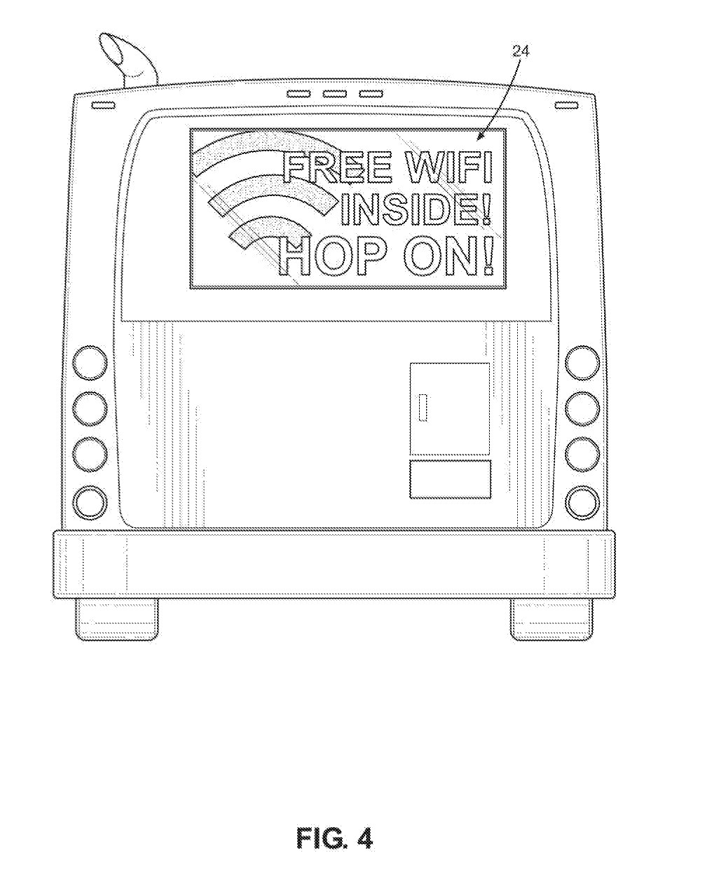

FIG. 3 shows another example of an ad 22. It will be appreciated that the nature of the ad may be passive or dynamic. Further, during times when ads of ad buyers are not displayed, other information, such as information 24 (FIG. 4) to promote bus ridership, weather information, and the like may be displayed.

Systems according to the disclosure are very dynamic and may incorporate virtually any combination of time, temperature, day of week, holiday, traffic condition, location, or other variables.

Additionally, systems according to the disclosure are desirably linked into the emergency alert system. Accordingly, the LED screens or other advertising displays will display Amber and Silver Alerts, as well as Severe Weather Alerts when they are pushed to the system.

The system also desirably provides advertising on the WiFi landing pages of the transit vehicles for the riders of those vehicles. The ads on these pages may also be displayed based on all the parameters for those of the rear of the vehicles.

Advertisement display may be based on various factors such as the global positioning system (GPS) location of the vehicle or specific to a vehicle. For example, a GPS device is mounted either inside or outside the vehicle. When the vehicle moves to different geographic locations, the advertisements change based on the geographic location. For example, when a vehicle is on the corner of Main street and 1st avenue, the vehicle displays advertisements based on that location. As the vehicle moves into another geographic location, it displays different advertisements based on the new location.

The advertisements may also be based on the specific vehicle. For example, vehicle one may display ads based specific to that vehicle. The number of ads, duration of ad length, time of day when ads are displayed, and conditions for which ads are displayed are all variable which may be applied and may be configured by the individual ad buyer or other entity.

For example, Restaurant X may advertise on Vehicle 1 irrespective of the vehicle's location. The ads may be based on either no conditions and display in normal rotation, or the ads can be displayed on a conditional basis to consider time of day, day of week, temperature, or any other variable the buyer prefers.

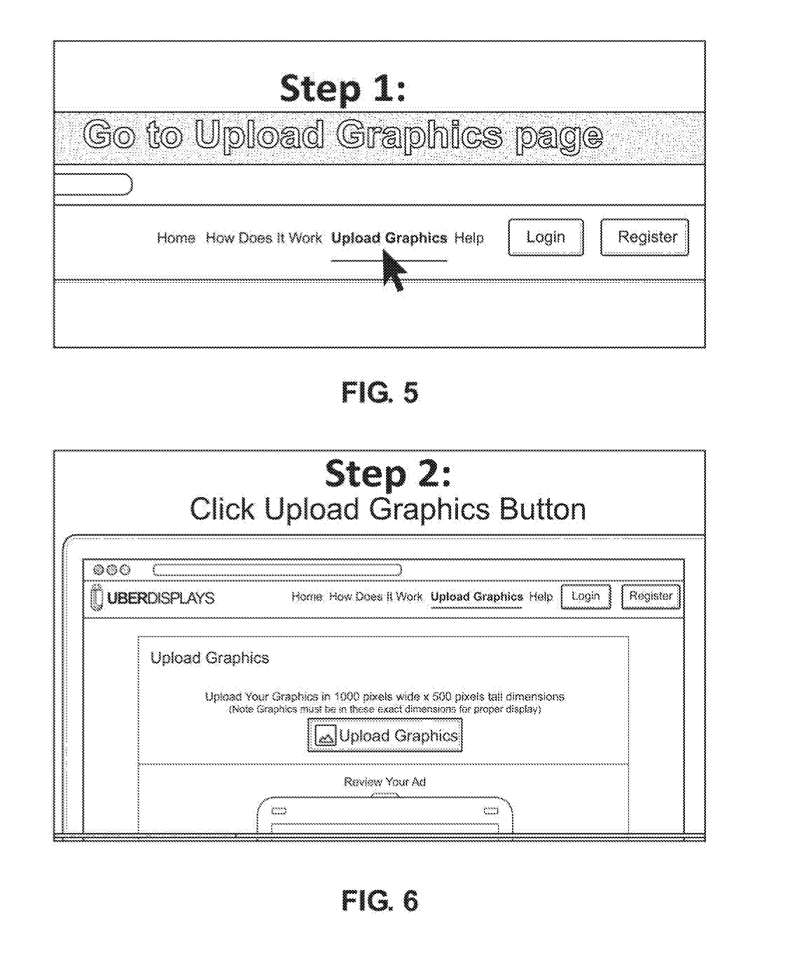

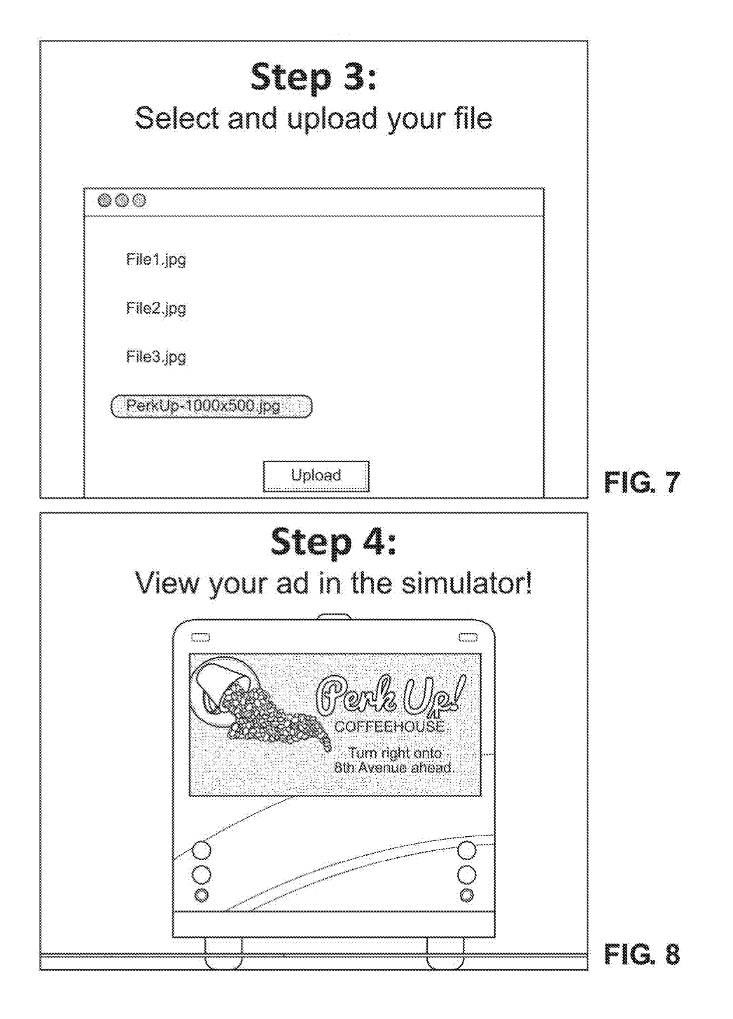

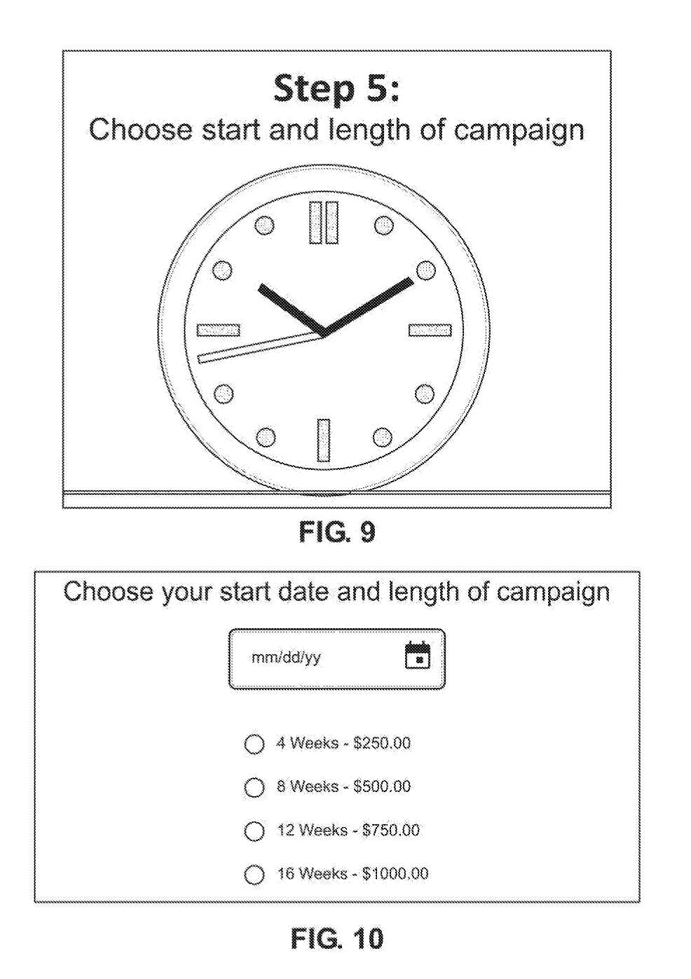

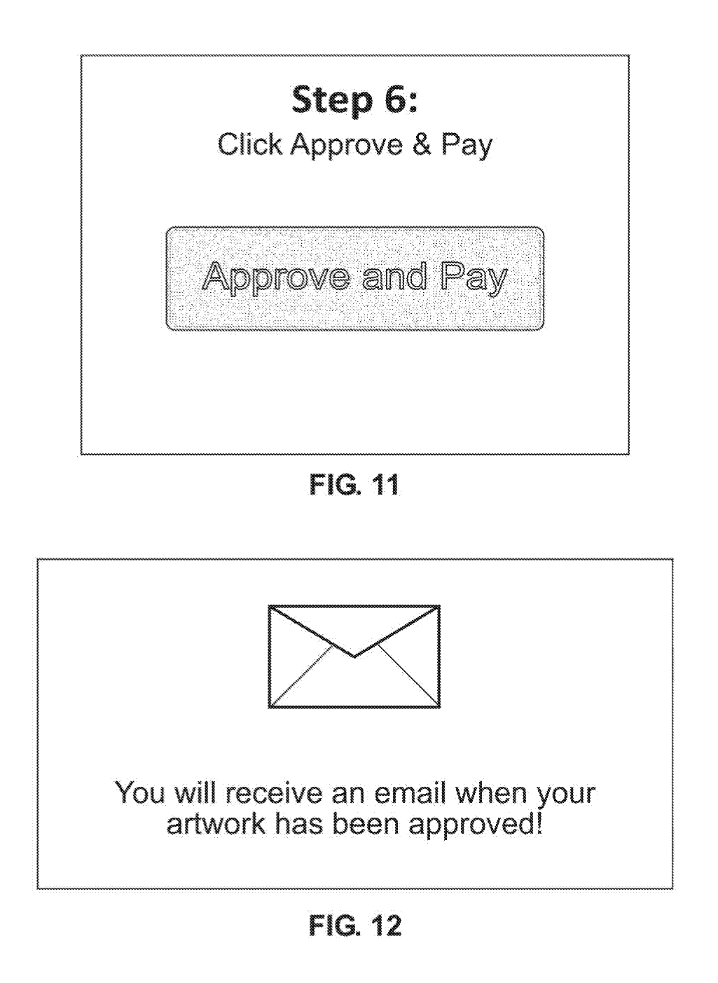

Turning now to FIGS. 5-12, and irrespective of geographic or vehicle-specific advertising, the ad buyer performs the following steps to advertise. In Steps 1-3 as seen in FIGS. 5-7, the ad buyer will log onto the provider website and upload advertising graphics. Next, in Step 4 (FIG. 8), the ad buyer reviews the uploaded ad for approval. If the ad is not acceptable, the ad buyer may upload a different ad. Next, assuming the ad is acceptable, the ad buyer in Steps 5 and 6 (FIGS. 9-12), will select the various options associated with the advertisement, such as start and length of the ad campaign, and purchase the ad.

After these steps are performed, the ad is then approved by the agency or entity on whose vehicles the ad will display, or is passively approved if agency/entity does not wish to approve each ad. When approved, the ad is immediately displayed on the vehicle.

If the ad buyer chooses to display on the transit vehicle, the buyer will select the vehicle(s) on which to advertise. If the ad buyer chooses to display based on geographic location, the buyer will select the region(s) on which to advertise.

For example, the ad buyer could choose to have his ad display in a Geographic Region 1 of Nashville, Tenn. The system 10 operates to display the ad buyer's ads in Geographic Region 1 on the exterior of the transit vehicle. When the vehicle travels to another geographic region, such as Geographic Region 2, only the ads designated for region 2 will display.

There are no limits as to the number of ads that may be purchased nor vehicles or geographic regions on which an advertiser may purchase to display. Software associated with the system 10 allows the ad buyer to select variables as criteria on which to determine how their ads will be displayed. There is no limit to the number or type of variables the ad buyer may select. Examples of these variables are, the time of day, day of week, time of year, temperature, weather, and special holidays to dictate how the ad will be displayed. Ads can display as singularly as hourly with no limit on duration.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. An advertising system configured to enable advertisements to be configured by a user via the internet, and then scheduled for display as desired on a remote advertising site, comprising:
a website configured to enable an ad buyer to log onto the website; upload and approve advertising graphics, and purchase times and geographic locations for display of the advertising graphics; and
a remote advertising display linked to the website via the internet,
wherein the advertisement is displayed on the remote advertising display at the times and geographic locations purchased by the ad buyer.

2. The advertising system of claim 1, wherein the remote advertising display is located on a vehicle that is transient and equipped with a GPS, and the advertisement is displayed on the remote advertising display when the vehicle is located at preselected geographic locations selected by the ad buyer.

3. The advertising system of claim 1, wherein the advertisement is displayed on the remote advertising display only when current weather conditions correspond to preselected weather conditions selected by the ad buyer.

4. The advertising system of claim 1, wherein the advertisement is displayed on the remote advertising display corresponding to variables selected by the ad buyer from the group consisting of date, time, temperature, and weather.

5. An advertising system configured to enable advertisements to be configured by a user via the internet, and then scheduled for display as desired on a remote advertising site, comprising:
a website configured to enable an ad buyer to log onto the website; upload and approve advertising graphics, and select variables for display of the advertising graphics; and
a remote advertising display linked to the website via the internet,
wherein the advertisement is displayed on the remote advertising display based on the variables selected by the ad buyer.

6. The system of claim 5, wherein the variables selected by the ad buyer comprise one or more of date, time, temperature, and weather.

7. A method of providing advertising, comprising the steps of:
providing a website configured to enable an ad buyer to log onto the website and enabling the ad buyer to upload and approve advertising graphics, and purchase times and geographic locations for display of the advertising graphics;
providing a remote advertising display linked to the website via the internet, and displaying the advertisement on the remote advertising display at the times and geographic locations purchased by the ad buyer.
